(19) United States
(12) Patent Application Publication
(10) Pub. No.: US 2012/0207026 A1
(43) Pub. Date: Aug. 16, 2012

(54) COMPUTER-READABLE MEDIUM STORING COMMUNICATION CONTROL PROGRAM, INFORMATION PROCESSING DEVICE, AND PACKET COMMUNICATION METHOD

(75) Inventor: Masahiro SATO, Kawasaki (JP)

(73) Assignee: FUJITSU LIMITED, Kawasaki-shi (JP)

(21) Appl. No.: 13/309,997

(22) Filed: Dec. 2, 2011

(30) Foreign Application Priority Data
Feb. 10, 2011 (JP) 2011-026997

(51) Int. Cl. H04L 12/56; H04L 12/26

(52) U.S. Cl. 370/237; 370/392

(57) ABSTRACT

In an information processing device, a storage stores address information including an address assigned to one endpoint of a tunnel and another address assigned to the other endpoint of the tunnel (a plurality of addresses are set with respect to at least one of the two endpoints). A controller selects, from the address information, source and destination addresses corresponding to the addresses of a captured packet. A transmitter transmits a packet obtained by encapsulating the captured packet and affixing the selected source and destination addresses to a tunnel header of the encapsulated packet.

### CROSS-REFERENCE TO RELATED APPLICATION

This application is based upon and claims the benefit of priority of the prior Japanese Patent Application No. 2011-026997, filed on Feb. 10, 2011, the entire contents of which are incorporated herein by reference.

### FIELD

The embodiments discussed herein are related to computer-readable media storing a communication control program, information processing devices, and packet communication methods.

### BACKGROUND

Currently, network virtualization technology is commonly used to construct a plurality of logical networks on a physical network. Network virtualization allows the reachable range of packets to be changed for each user, without the need to change the physical interconnections between communication devices. Conceivably, the virtualization technology may be used for a Layer 2 network of a data center used by multiple users, for example, so that the packets may be logically isolated according to users.

As a method of implementing network virtualization, tunneling has been known in which a tunnel is created between communication devices. In the tunneled section, packets encapsulated and affixed with a tunnel header are transmitted. A packet that is to pass through the tunnel is encapsulated at one endpoint (head point) of the tunnel and is decapsulated at the other endpoint. To allow the packet to be transmitted through the tunneled section, the encapsulated packet is affixed, as source and destination addresses, with the addresses of the communication devices at the opposite ends of the tunnel, for example.

Meanwhile, some networks have redundant paths so that there may exist a plurality of physical paths between a certain source and destination of packets. As routing control techniques for such redundant paths, there have been known STP (Spanning Tree Protocol) and multipath routing technique. In the STP, a loop present within the network is detected and the use of some links between communication devices is prohibited so that the loop may be logically resolved. In the multipath routing technique, on the other hand, packets are transmitted dispersedly by using multiple paths. For example, it is conceivable that a path for transmitting a packet is selected on the basis of the source and destination addresses affixed to the packet. By using the multipath routing technique, it is possible to improve the efficiency in the use of links between communication devices.

In connection with the multipath routing technique, a packet relay device has been proposed which is provided with a multipath routing table in which multiple paths are registered with respect to a single destination address, and the multipath routing table is looked up to select an interface for outputting a received packet. Also, a packet relay device has been proposed in which the source address of a packet is converted to a virtual IP (Internet Protocol) address which is varied depending upon the application type, and the packet is output to an IP network in which multiple paths are set up, so that the packet return path may become identical with the forward path.

Japanese Laid-open Patent Publication No. 2006-165952

Japanese Laid-open Patent Publication No. 2001-160825

Let us consider the case where both the network virtualization using the tunneling method and the multipath routing technique are applied to a network (e.g., Layer 2 network) for transmitting packets. In such case, if a packet is encapsulated using the physical addresses of communication devices at the opposite ends of the tunnel, however, then it is not possible for the routing control to recognize, within the tunneled section, address differences from the original source and destination addresses assigned to the packet before the encapsulation (flow differences). Thus, even if multiple paths are set up within the tunneled section, it is difficult to transmit encapsulated packets dispersedly via the multiple paths, giving rise to the problem that the transmission efficiency lowers.

### SUMMARY

According to one aspect of the present invention, there is provided a computer-readable medium storing a communication control program for processing packets that are transmitted through a network in which a tunnel is created and a plurality of paths are set up within a tunneled section of the tunnel. The communication control program causes a computer provided with a storage storing address information which includes a first source address assigned to one endpoint of the tunnel and a first destination address assigned to an opposite endpoint of the tunnel and in which a plurality of entries are set with respect to at least one of the first source and destination addresses, to execute a process including: capturing a first packet including a second source address and a second destination address, and selecting, from the address information, the first source and destination addresses corresponding to the second source and destination addresses; and affixing the selected first source and destination addresses to a tunnel header of the first packet, to generate an encapsulated second packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an information processing device according to a first embodiment;

FIG. 2 illustrates a communication system according to a second embodiment;

FIG. 3 is a block diagram exemplifying hardware of a server apparatus;

FIG. 4 is a block diagram illustrating an exemplary layout of virtual machines;

FIG. 5 is a block diagram illustrating another exemplary layout of virtual machines;

FIG. 6 illustrates exemplary packet formats;

FIG. 7 is a block diagram of a virtual switch in the server apparatus;

FIG. 8 exemplifies a virtual address table;

FIG. 9 exemplifies a flow management table;

FIG. 10 exemplifies a routing table;

FIG. 11 is a flowchart illustrating a packet transmission process;

FIG. 12 is a flowchart illustrating a packet reception process;

FIG. 13 is a first diagram illustrating an example of packet communication procedure;

FIG. 14 is a second diagram illustrating an example of packet communication procedure;

FIG. 15 is a third diagram illustrating an example of packet communication procedure;

FIG. 16 is a fourth diagram illustrating an example of packet communication procedure; and

FIG. 17 is a fifth diagram illustrating an example of packet communication procedure.

### DESCRIPTION OF EMBODIMENTS

Embodiments of the present invention will be described below with reference to the accompanying drawings, wherein like reference numerals refer to like elements throughout.

### [a] First Embodiment

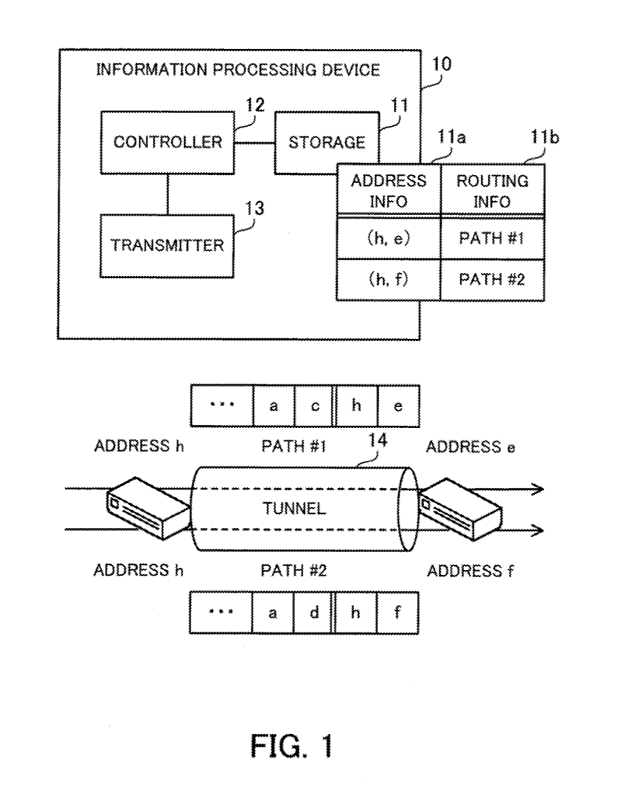

FIG. 1 illustrates an information processing device according to a first embodiment. The information processing device 10 of the first embodiment processes packets that are transmitted through a network in which a tunnel 14 is created and a plurality of paths (e.g., paths #1 and #2) are set up within a tunneled section of the tunnel 14. The information processing device 10 includes a storage 11, a controller 12, and a transmitter 13.

The storage 11 holds address information 11a. The address information 11a includes an address (first source address) assigned to one endpoint of the tunnel 14, and an address (first destination address) assigned to the other endpoint of the tunnel 14. A plurality of addresses are assigned to at least one of the opposite endpoints of the tunnel 14 (preferably, a plurality of first destination addresses are set). For example, an address “h” is assigned to one endpoint, and addresses “e” and “f” are assigned to the other endpoint. The addresses indicated by the address information 11a may include the physical address of a communication device at an endpoint of the tunnel 14. For example, either one of the addresses “e” and “f” may be a physical address. Alternatively, all of the addresses indicated by the address information 11a may be virtual addresses.

The controller 12 captures a packet including a source address (second source address) and a destination address (second destination address). Then, in accordance with the source and destination addresses of the captured packet, the controller 12 selects source and destination addresses to be used for encapsulation, from the address information 11a stored in the storage 11. For example, the controller 12 selects a pair of source and destination addresses for the encapsulation such that original packets with an identical source address-destination address pair are assigned an identical source address-destination address pair for the encapsulation. Where a packet with an unknown address pair has arrived, the controller 12 selects an address pair for the encapsulation so that the frequency of usage of the address pairs may be averaged (e.g., by a round-robin method).

The transmitter 13 outputs an encapsulated packet to the network to be transmitted through the tunnel 14. The encapsulated packet is obtained by affixing, to the captured original packet, a tunnel header and the source and destination addresses selected by the controller 12. A transmission path for the packet within the tunnel 14 is selected in accordance with the source and destination addresses affixed to the tunnel header (selected by the controller 12). For example, a packet with an address pair (a, c) is encapsulated using an address pair (h, e) and transmitted through the path #1, and a packet with an address pair (a, d) is encapsulated using an address pair (h, f) and transmitted through the path #2.

The transmission path for encapsulated packets may be selected either by the information processing device 10 or by communication devices (e.g., switches) on the network. In the former case, the storage 11 holds routing information 11b correlating the source and destination addresses used for the encapsulation with identification information identifying a path within the tunnel 14. Looking up the routing information 11b stored in the storage 11, the controller 12 controls the transmission of packets such that the packets are transmitted via the paths corresponding to their source address-destination address pairs for the encapsulation. For example, the controller 12 causes the identification information in the routing information 11b to be affixed to the tunnel header. The communication devices within the tunnel 14 are set so as to forward the packets along the paths determined by the destination address and the identification information affixed to the tunnel header.

The controller 12 may take into account the status of congestion within the tunnel 14 when selecting the source and destination addresses for the encapsulation. For example, the controller 12 acquires congestion information about a path with respect to which congestion has been detected, from a communication device on the network. The congestion information includes, for example, the source and destination addresses (source and destination addresses affixed for the purpose of encapsulation) of a packet that was forwarded to but failed to be transmitted through the congested path. On the basis of the acquired congestion information, the controller 12 places restrictions on the address pairs that can be selected for the encapsulation, among the address pairs indicated by the address information 11a. For example, the source address-destination address pair indicated by the congestion information is excluded from the selectable address pairs.

By using tunneling technology for network virtualization, it is possible to attain higher scalability than in the case of using VLAN (Virtual Local Area Network) technology. As the method of creating the tunnel 14, Layer 2 tunneling or Layer 3 tunneling may be used. The tunneling technology includes GRE (Generic Routing Encapsulation), IPoverIP, and the like. The information processing device 10 may be configured to function as a communication device located at one endpoint of the tunnel 14. Also, the information processing device 10 may be implemented by causing a computer provided with the storage 11 to execute a predetermined communication control program. The term “packet” also covers herein transmission units called by other names, such as “frame”, and the aforementioned source and destination addresses may be MAC (Medium Access Control) addresses.

In the information processing device 10 of the first embodiment, the first packet including the second source and destination addresses is captured, and the first source and destination addresses corresponding to the second source and destination addresses are selected from the address information 11a. Then, the first packet is encapsulated with the selected first source and destination addresses affixed to the tunnel header thereof and is transmitted as the encapsulated second packet.

It is therefore possible to prepare multiple pairs of source and destination addresses that can be used for the encapsulation. Thus, even within the tunnel 14, multiple flows can be distinguished from one another on the basis of the source and destination addresses affixed for the purpose of encapsulation. Consequently, encapsulated packets can be transmitted dispersedly via the multiple paths set up within the tunnel 14, enabling efficient transmission of encapsulated packets. Also, the packet dispersion serves to suppress the occurrence of congestion on the network.

### [b] Second Embodiment

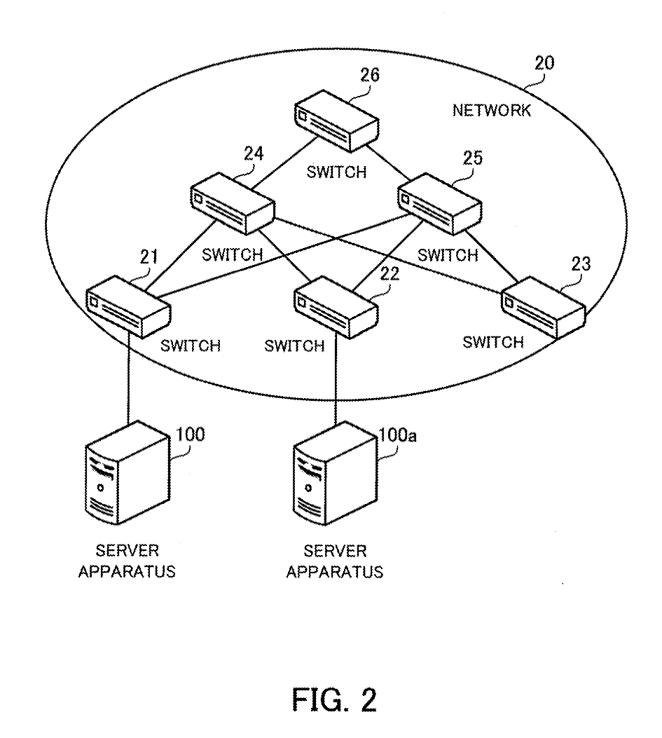

FIG. 2 illustrates a communication system according to a second embodiment. As the second embodiment, a communication system will be considered wherein virtual machines (VM) implemented by multiple server apparatuses communicate with one another over a Layer 2 network. The communication system of the second embodiment may be provided, for example, at a data center used by multiple users. The communication system includes a network 20, which includes switches 21 to 26, and server apparatuses 100 and 100a.

The switches 21 to 26 are each a communication device for forwarding packets. The switch 21 is connected to the server apparatus 100, and the switch 22 is connected to the server apparatus 100a. Paths set up between the server apparatuses 100 and 100a include a path passing through the switches 21, 24 and 22, and a path passing through the switches 21, 25 and 22. By virtualizing the network 20 with the use of tunneling technology, it is possible to construct a logical network for each user. The switches 21 to 26 are capable of forwarding encapsulated packets affixed with the tunnel header. Also, multipath routing may be implemented on the network 20.

The server apparatuses 100 and 100a are each an information processing device having the ability to implement a plurality of virtual machines, which are logical computers. Each virtual machine processes information by using the range of hardware resources allocated thereto. In the server apparatuses 100 and 100a, software called virtual switch is executed. The virtual switch transmits, to the network 20, the packets output from the virtual machines, and distributes the packets received from the network 20, to the respective virtual machines specified by the destination addresses. Where a virtual machine on the server apparatus 100 communicates with a virtual machine on the server apparatus 100a, a tunnel is created, for example, between the server apparatuses 100 and 100a. The virtual switches serve as communication devices at the respective endpoints of the tunnel to control the tunnel communication.

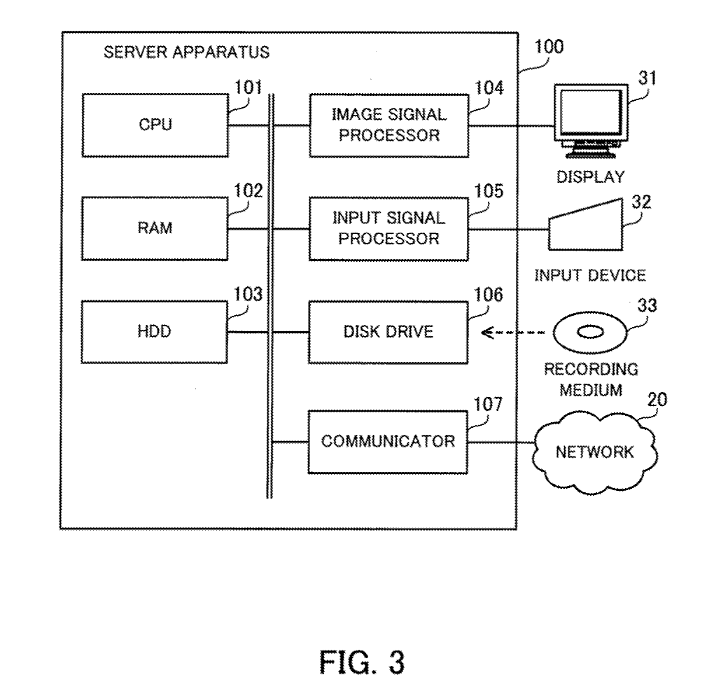

FIG. 3 is a block diagram exemplifying hardware of the server apparatus. The server apparatus 100 includes a CPU (Central Processing Unit) 101, a RAM (Random Access Memory) 102, an HDD (Hard Disk Drive) 103, an image signal processor 104, an input signal processor 105, a disk drive 106, and a communicator 107. These units are interconnected by a bus inside the server apparatus 100. The server apparatus 100a may also be implemented using hardware identical with that of the server apparatus 100.

The CPU 101 is an arithmetic and logic unit that controls the information processing of the server apparatus 100. The CPU 101 loads at least part of a program and data stored in the HDD 103, into the RAM 102 to execute the program. The server apparatus 100 may be equipped with a plurality of CPUs.

The RAM 102 is a volatile memory for temporarily storing programs and data handled by the CPU 101. The server apparatus 100 may be provided with a plurality of RAMs or a plurality of other kinds of memory than RAM.

The HDD 103 is a nonvolatile storage device for storing programs, such OS (Operating System) programs and application programs, as well as data used for the processing by the CPU 101. The HDD 103 reads and writes data from and onto a magnetic disk built therein. The server apparatus 100 may be equipped with a plurality of HDDs or a plurality of other kinds of nonvolatile storage devices than HDD (e.g., SSD (Solid State Drive)).

In accordance with instructions from the CPU 101, the image signal processor 104 causes a display 31 connected to the server apparatus 100 to display images thereon. For the display 31, a CRT (Cathode Ray Tube) display or a liquid-crystal display may be used, for example.

The input signal processor 105 acquires an input signal from an input device 32 connected to the server apparatus 100, and outputs the input signal to the CPU 101. For the input device 32, a pointing device, such as a mouse, and a keyboard may be used, for example.

The disk drive 106 is a drive unit for reading out programs and data recorded on a recording medium 33. For the recording medium 33, a magnetic disk such as a flexible disk (FD), an optical disc such as a CD (Compact Disc) or DVD (Digital Versatile disc), or a magneto-optical disk (MO) may be used, for example. For example, in accordance with instructions from the CPU 101, the disk drive 106 outputs the program or data read from the recording medium 33 to the RAM 102 or the HDD 103.

The communicator 107 is a communication interface connected to the network 20 for communication. The form of connection to the network 20 may be either wired or wireless. Namely, the communicator 107 may be a wired communication interface or a wireless communication interface.

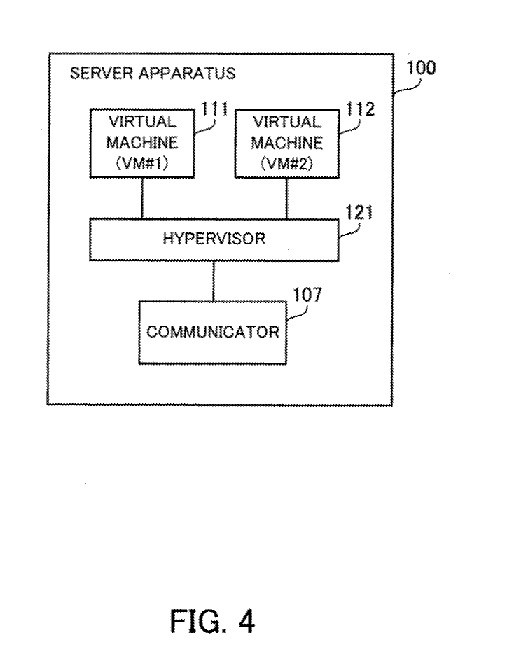

FIG. 4 is a block diagram illustrating an exemplary layout of virtual machines. As the program is executed by the server apparatus 100, virtual machines 111 (VM#1) and 112 (VM#2) and a hypervisor 121, for example, are implemented within the server apparatus 100.

The virtual machines 111 and 112 perform user-requested information processing by using the hardware resources (processing capacity of the CPU, storage area of the RAM, and the like) allocated by the hypervisor 121. The operating system (OS) is executed for each virtual machine. Each of the virtual machines 111 and 112 is assigned a MAC address and is capable of communicating with other virtual machines. The hypervisor 121 allocates the hardware resources of the server apparatus 100 to the virtual machines 111 and 112, and manages the execution of the virtual machines 111 and 112.

The hypervisor 121 has a virtual switch. The virtual switch manages the communication band between the server apparatus 100 and the network 20, and processes packets exchanged between the virtual machines 111 and 112 and the communicator 107. The virtual switch transmits the packets output from the virtual machines 111 and 112, to the network 20 via the communicator 107, as stated above. Also, the virtual switch distributes the packets received from the network 20 via the communicator 107, to the virtual machines 111 and 112 in accordance with their destination MAC addresses. Further, the virtual switch functions as a communication device at an endpoint of the tunnel, to process packets transmitted through the tunnel.

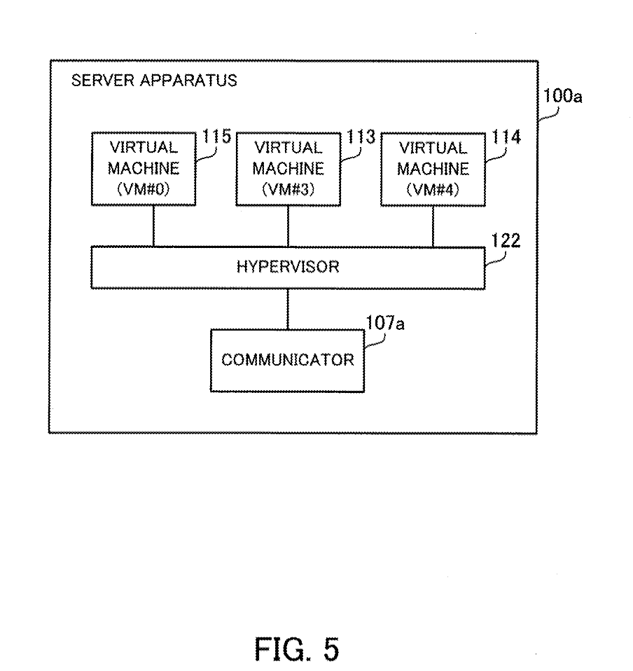

FIG. 5 is a block diagram illustrating another exemplary layout of virtual machines. As the program is executed by the server apparatus 100a, virtual machines 113 (VM#3), 114 (VM#4) and 115 (VM#0) and a hypervisor 122, for example, are implemented within the server apparatus 100a. The server apparatus 100a has a communicator 107a.

The virtual machines 113 and 114 carry out user-requested information processing, like the aforementioned virtual machines 111 and 112. The virtual machine 115 is a device controlling virtual machine which accepts instructions from the virtual machines 113 and 114 via the hypervisor 122 and accesses various devices. The hypervisor 122 allocates the hardware resources of the server apparatus 100a to the virtual machines 113 to 115. Also, the hypervisor 122 has a virtual switch for transferring packets between the virtual machines 113 and 114 and the communicator 107a.

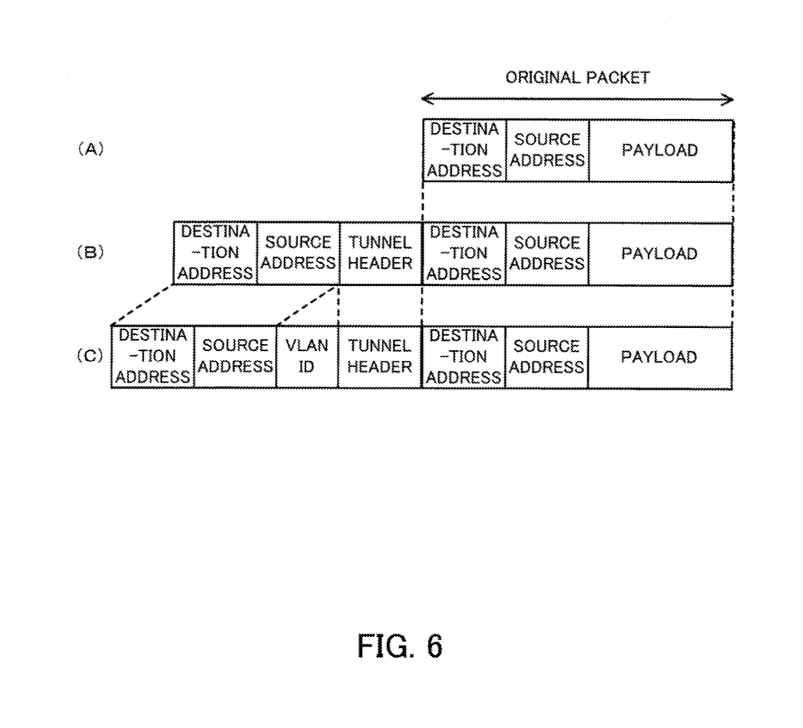

FIG. 6 illustrates exemplary packet formats. Packets output from the virtual machines 111 to 114 each include a MAC address specifying a destination virtual machine, a MAC address specifying a source virtual machine, and a payload (part (A) of FIG. 6). The virtual switch affixes, to the packet output from the virtual machine, a tunnel header and destination and source MAC addresses for encapsulation (part (B) of FIG. 6). Multiple pairs of destination and source MAC addresses for encapsulation are prepared for each tunnel.

Multiple paths are set up within the tunneled section of the network 20. For example, a path passing though the switches 21, 24 and 22 and a path passing through the switches 21, 25 and 22 are set up. Which path to use within the tunneled section is determined in accordance with the destination and source MAC addresses affixed for the purpose of encapsulation. To control multipath routing at the individual switches, a method called SPAIN (Smart Path Assignment In Networks) may be used, for example. In SPAIN, VLAN ID is used so that each switch can recognize the selected path. An explanation of SPAIN can be found, for example, in Jayaram Mudigonda, Praveen Yalagandula, Mohammad Al-Fares and Jeffrey C. Mogul, SPAIN: Design and Algorithms for Constructing Large Data-Center Ethernets from Commodity Switches, Oct. 8, 2009.

The virtual switch selects a path through which the encapsulated packet is to be transmitted, from among the multiple paths set up in the network 20, and further affixes a VLAN ID corresponding to the selected path. The VLAN ID is inserted, for example, between the tunnel header and the destination and source MAC addresses for the encapsulation (part (C) of FIG. 6). Each switch in the tunneled section holds information correlating VLAN IDs with paths, for example, and identifies the forwarding destination of the packet on the basis of the VLAN ID and the destination MAC address for the encapsulation.

The method of using VLAN ID is, however, just an example of multipath routing control, and any other method may be used insofar as packets can be transmitted through selected paths. Also, the path selection may be carried out on the side of the network 20, instead of the server apparatuses 100 and 100a. In this case, in accordance with the destination and source MAC addresses for the encapsulation, each of the switches 21 and 22 selects the path through which the encapsulated packet is to be transmitted. Then, the switch inserts a VLAN ID corresponding to the selected path in the packet, for example, and forwards the packet to the next switch.

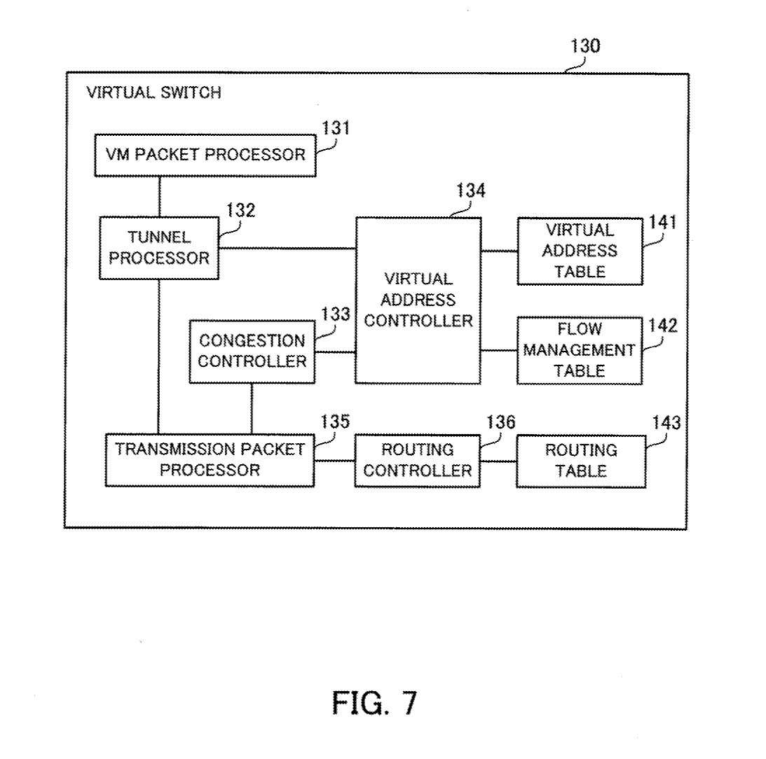

FIG. 7 is a block diagram of the virtual switch in the server apparatus. The virtual switch 130 is included in the hypervisor 121 of the server apparatus 100. The virtual switch included in the hypervisor 122 of the server apparatus 100a can also be implemented using a configuration identical with that of the virtual switch 130. The virtual switch 130 includes a VM (Virtual Machine) packet processor 131, a tunnel processor 132, a congestion controller 133, a virtual address controller 134, a transmission packet processor 135, and a routing controller 136.

The VM packet processor 131 captures packets output from the virtual machines 111 and 112, and outputs the captured packets to the tunnel processor 132. The VM packet processor 131 holds information about the MAC addresses assigned to the respective virtual machines 111 and 112. When a decapsulated packet is received from the tunnel processor 132, the VM packet processor 131 outputs the received packet to the virtual machine specified by the destination MAC address included in the packet.

The tunnel processor 132 encapsulates outgoing packets to be transmitted through the tunnel and also decapsulates the incoming packets that have been forwarded through the tunnel. The tunnel processor 132 captures the packet output from the VM packet processor 131, and inquires of the virtual address controller 134 about destination and source MAC addresses to be used for encapsulating the packet. Then, using the MAC addresses selected by the virtual address controller 134, the tunnel processor 132 encapsulates the packet and outputs the encapsulated packet to the transmission packet processor 135. Also, the tunnel processor 132 captures an encapsulated packet output from the transmission packet processor 135, then removes the tunnel header from the packet, and outputs the resulting packet to the VM packet processor 131. When the packet is decapsulated, the tunnel processor 132 notifies the virtual address controller 134 of the correspondence relationship between the original MAC addresses and the MAC addresses affixed for the encapsulation.

The congestion controller 133 captures a congestion control packet output from the transmission packet processor 135. The congestion control packet is a control packet transmitted from a switch that has detected congestion. The congestion control packet includes the destination and source MAC addresses (MAC addresses affixed for the encapsulation) of a packet which was discarded because of congestion. The congestion controller 133 extracts the MAC addresses included in the congestion control packet, and notifies the virtual address controller 134 of the extracted MAC addresses.

The virtual address controller 134 manages the destination MAC addresses (virtual destination addresses) and source MAC addresses (virtual source addresses) to be affixed to the tunnel header, by using a virtual address table 141 and a flow management table 142. When a packet is to be transmitted, the virtual address controller 134 selects MAC addresses to be used for the encapsulation, in accordance with the MAC addresses of the original packet. On the other hand, when a packet is received, the virtual address controller 134 checks the correspondence between the original MAC addresses of the received packet and the MAC addresses used for the encapsulation and, if necessary, updates the correspondence between the MAC address pairs. Further, when the congestion control packet is received, the virtual address controller 134 imposes restrictions on the MAC addresses to be used for the encapsulation so that the congested path may not be selected.

The transmission packet processor 135 captures the encapsulated packet output from the tunnel processor 132, and inquires of the routing controller 136 about a path through which the packet is to be transmitted. Then, the transmission packet processor 135 affixes the VLAN ID selected by the routing controller 136 to the tunnel header, and outputs the resulting packet to the communicator 107. Also, the transmission packet processor 135 captures an encapsulated packet output from the communicator 107, then removes the VLAN ID from the tunnel header, and outputs the resulting packet to the tunnel processor 132. Further, on capturing the congestion control packet, the transmission packet processor 135 outputs the captured packet to the congestion controller 133.

The routing controller 136 controls packet transmission routing by using a routing table 143. When a packet is to be transmitted, the routing controller 136 selects a path correlated with the destination and source MAC addresses of the packet (encapsulated packet) captured by the transmission packet processor 135, and then selects a VLAN ID indicative of the selected path.

The virtual address table 141, the flow management table 142 and the routing table 143 are stored in a storage device such as the RAM 102 or the HDD 103. The virtual address table 141 indicates the pairs of destination and source MAC addresses that can be used for the encapsulation. The flow management table 142 indicates the correspondence relationships between the MAC addresses originally assigned before the encapsulation and those affixed for the purpose of encapsulation. The routing table 143 indicates the correspondence relationships between the MAC addresses affixed for the purpose of encapsulation and VLAN IDs for identifying respective paths.

Where the path selection is performed on the side of the network 20, and not by the server apparatus 100, the routing controller 136 and the routing table 143 may be omitted from the virtual switch 130. In this case, the switch 21, for example, is provided with a function equivalent to that of the routing controller 136 as well as with data corresponding to the routing table 143.

The storage device storing the virtual address table 141, the flow management table 142 and the routing table 143 is an example of the storage 11 of the first embodiment. The tunnel processor 132, the congestion controller 133, the virtual address controller 134 and the routing controller 136 are an example of the controller 12 of the first embodiment. Also, the transmission packet processor 135 and the communicator 107 are an example of the transmitter 13 of the first embodiment.

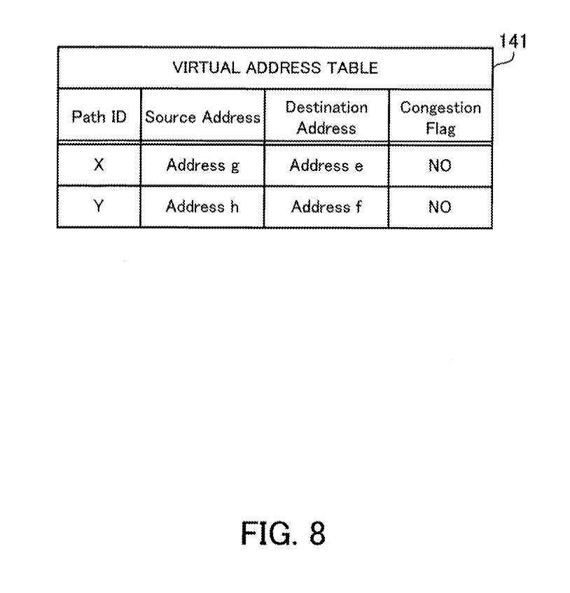

FIG. 8 illustrates an example of the virtual address table. The virtual address table 141 is stored in a storage area accessible from the virtual switch 130. The virtual address table 141 has columns respectively indicating path ID, source address, destination address, and congestion flag.

The path ID is identification information for identifying a pair of virtual destination and source addresses. Where an address pair and a path on the network 20 are in one-to-one correspondence, the path ID indicates a path. The source address is a virtual address (virtual source address) assigned to the server apparatus 100 as a transmitting endpoint of the tunnel. The destination address is a virtual address (virtual destination address) assigned to the server apparatus 100a as a receiving endpoint of the tunnel. The path IDs, the source addresses and the destination addresses are set beforehand by an administrator, for example. The congestion flag indicates whether the path with which the address pair is associated is congested or not. The congestion flag is updated by the virtual address controller 134.

The server apparatus 100 is assigned, for example, addresses “g” and “h” as the virtual addresses. Either one of the addresses “g” and “h” may be the physical MAC address of the server apparatus 100, or both may be addresses different from the physical MAC address. The server apparatus 100a is assigned addresses “e” and “f” as the virtual addresses. Either one of the addresses “e” and “f” may be the physical MAC address of the server apparatus 100a, or both may be addresses different from the physical MAC address. Then, (e, g) and (f, h), for example, are defined as pairs of virtual destination and source addresses. An address pair of which at least one of the virtual destination and source addresses differs from the corresponding address of another address pair is recognized as a separate address pair. In the virtual address table held by the server apparatus 100a, the sources and the destinations are registered reversely, compared to the virtual address table 141.

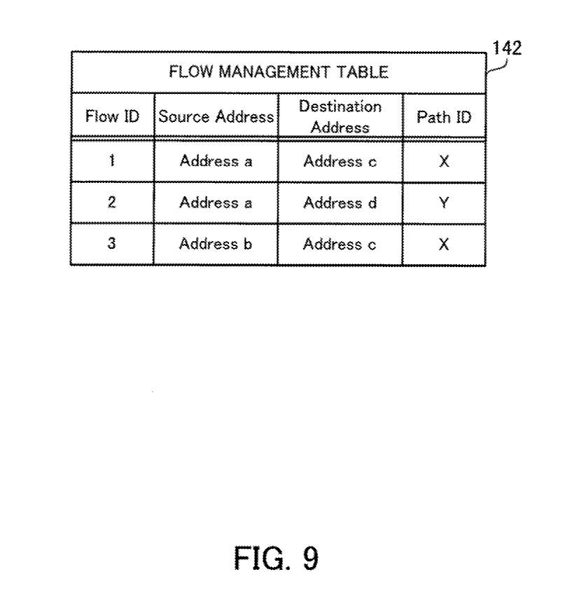

FIG. 9 illustrates an example of the flow management table. The flow management table 142 is stored in a storage area accessible from the virtual switch 130. The flow management table 142 includes columns respectively indicating flow ID, source address, destination address, and path ID.

The flow ID is identification information for identifying a pair of destination and source MAC addresses and corresponds to a packet flow. The source address is the MAC address assigned to a virtual machine as the source of the packet, and the destination address is the MAC address assigned to a virtual machine as the destination of the packet. In the flow management table held by the server apparatus 100a, the sources and the destinations are registered reversely, compared to the flow management table 142. The path ID indicates the pair of virtual addresses selected from the virtual address table 141. The flow management table 142 is updated by the virtual address controller 134.

One pair of MAC addresses of virtual machines is correlated with one pair of virtual addresses. The virtual address pairs are used for the selection of paths within the tunneled section and, therefore, are preferably used as evenly as possible in order that packets may be dispersed among the multiple paths. For example, each time a new pair of MAC addresses of virtual machines is detected, the virtual address controller 134 selects a path ID by a round-robin method. Where two pairs of virtual addresses have been defined, it is conceivable that the two paths are alternately selected. In FIG. 9, the MAC address of the virtual machine VM#1 is represented by “a”, the MAC address of the virtual machine VM#2 by “b”, the MAC address of the virtual machine VM#3 by “c”, and the MAC address of the virtual machine VM#4 by “d”.

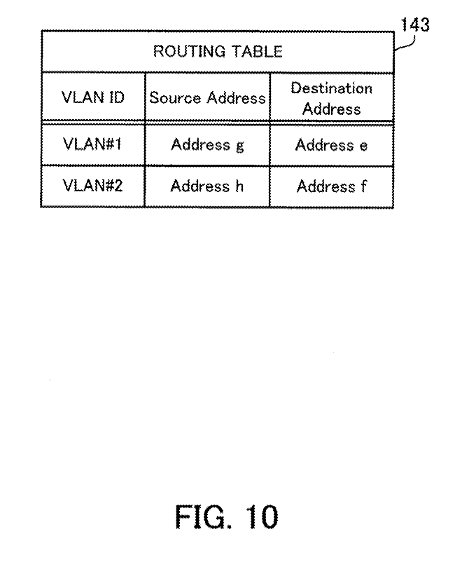

FIG. 10 illustrates an example of the routing table. The routing table 143 is stored in a storage area accessible from the virtual switch 130. The routing table 143 includes columns respectively indicating VLAN ID, source address, and destination address.

The VLAN ID denotes a VLAN ID affixed to the tunnel header of an encapsulated packet. The VLAN ID is used so that the switches 21 to 26 can recognize the path selected by the server apparatus 100 to locate the forwarding destination of the packet. The source address is the virtual source address affixed to the tunnel header, and the destination address is the virtual destination address affixed to the tunnel header. In the routing table held by the server apparatus 100a, the sources and the destinations are registered reversely, compared to the routing table 143. The correspondence relationships between the VLAN IDs and the virtual address pairs in the routing table 143 are defined in advance by the administrator, for example.

In each of the switches 21 to 26, forwarding information for identifying a forwarding destination from the VLAN ID and the MAC address is registered. By virtue of the forwarding information, a packet affixed with the VLAN ID “VLAN#1” and the destination address “e”, for example, is forwarded via the switches 21, 24 and 22 in the mentioned order, and a packet affixed with the VLAN ID “VLAN#1” and the destination address “g” is forwarded via the same switches in reverse order (path X). Also, a packet affixed with the VLAN ID “VLAN#2” and the destination address “f” is forwarded via the switches 21, and 22 in the mentioned order, and a packet affixed with the VLAN ID “VLAN#2” and the destination address “h” is forwarded via the same switches in reverse order (path Y).

In the exemplary tables illustrated in FIGS. 8 to 10, each path set up in the network 20 is correlated one to one with a pair of virtual addresses. By correlating a path one to one with a virtual address pair, it is possible to attain multipath routing while efficiently using a small number of virtual addresses. A path has only to be uniquely identified from a pair of virtual addresses, and therefore, a single path may be correlated with multiple pairs of virtual addresses.

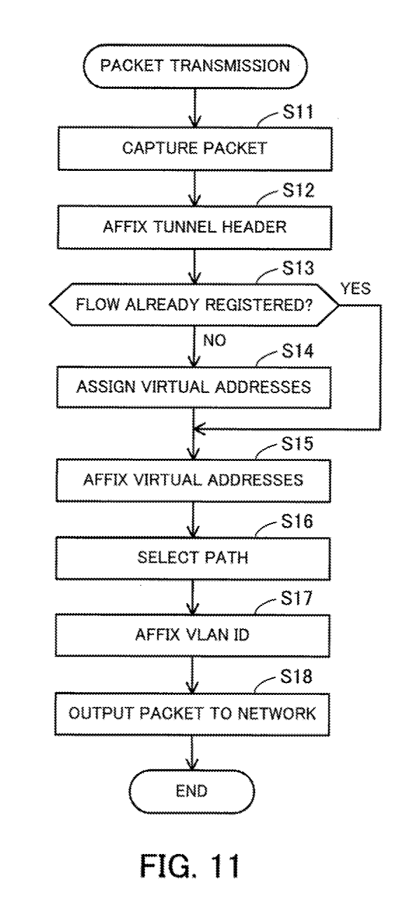

FIG. 11 is a flowchart illustrating a packet transmission process. Assuming that the virtual machine 111 (VM#1) of the server apparatus 100 transmits a packet addressed to the virtual machine 113 (VM#3) of the server apparatus 100a, the process illustrated in FIG. 11 will be explained in order of step number.

Step S11: The VM packet processor 131 captures a packet with the destination and source MAC addresses “c” and “a”, respectively, output from the virtual machine VM#3.

Step S12: The tunnel processor 132 affixes a tunnel header to the packet output from the virtual machine VM#3. The contents of the tunnel header depend upon the tunneling protocol used.

Step S13: The virtual address controller 134 checks the MAC addresses of the packet output from the virtual machine VM#3 and determines whether or not a flow with the destination and source MAC addresses “c” and “a”, respectively, is registered in the flow management table 142. If the flow is not registered, the process proceeds to Step S14; if the flow is registered, the process proceeds to Step S15.

Step S14: The virtual address controller 134 selects a path ID from the virtual address table 141 by a round-robin method or the like. Then, the virtual address controller 134 registers the destination MAC address “c”, the source MAC address “a” and the selected path ID in the flow management table 142. As a result, the packet flow is assigned the virtual addresses. In this case, however, the virtual address controller 134 avoids selecting a path ID associated with the congestion flag “YES” in the virtual address table 141.

Step S15: The virtual address controller 134 selects, from the virtual address table 141, the virtual address pair (virtual destination address “e”; virtual source address “g”) assigned to the destination and source MAC addresses “c” and “a”. The tunnel processor 132 then affixes the selected virtual address pair to the tunnel header.

Step S16: The routing controller 136 checks the MAC addresses of the packet encapsulated by the tunnel processor 132, and then selects the VLAN ID (VLAN#1) corresponding to the virtual destination and source addresses “e” and “g”, from the routing table 143. As a result, a path for transmitting the encapsulated packet is selected.

Step S17: The transmission packet processor 135 affixes the VLAN ID selected by the routing controller 136 to the tunnel header.

Step S18: The transmission packet processor 135 outputs the encapsulated packet to the communicator 107. The communicator 107 transmits the packet output from the transmission packet processor 135 to the switch 21. Consequently, the encapsulated packet is transmitted via the switches 21, 24 and 22 to the server apparatus 100a.

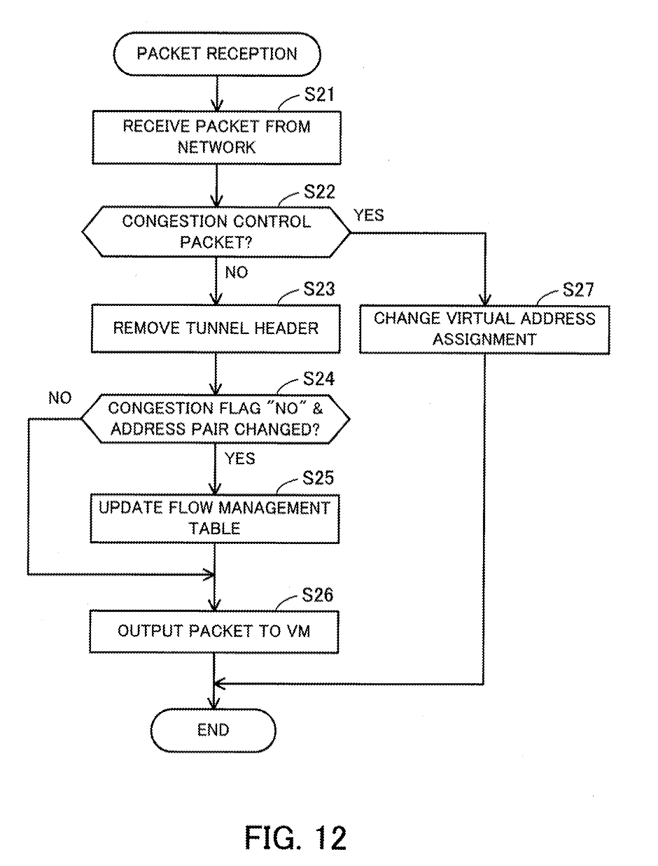

FIG. 12 is a flowchart illustrating a packet reception process. Assuming that the virtual machine VM#1 of the server apparatus 100 receives a packet from the virtual machine VM#3 of the server apparatus 100a, the process illustrated in FIG. 12 will be explained in order of step number.

Step S21: The transmission packet processor 135 captures an encapsulated packet output from the communicator 107. In the case of a packet transmitted from the virtual machine VM#3 to the virtual machine VM#1, the virtual destination address “g”, the virtual source address “e”, the VLAN ID “VLAN#1”, the destination MAC address “a” and the source MAC address “c” are affixed to the packet output from the communicator 107.

Step S22: The transmission packet processor 135 determines whether the packet acquired from the communicator 107 is a congestion control packet or not. Whether the packet is a congestion control packet or not is determined on the basis of the header information, for example. If the packet is not a congestion control packet, the process proceeds to Step S23; if the packet is a congestion control packet, the process proceeds to Step S27.

Step S23: The transmission packet processor 135 removes the VLAN ID (VLAN#1) from the packet. Then, the tunnel processor 132 removes, from the packet, the virtual destination address “g”, the virtual source address “e” and the tunnel header.

Step S24: The virtual address controller 134 looks up the virtual address table 141 to check the congestion flag associated with the virtual destination and source addresses “e” and “g” (reversal of the source and destination of the received packet). Also, the virtual address controller 134 looks up the flow management table 142 to determine whether or not the virtual address pair assigned to the destination and source MAC addresses “c” and “a” (reversal of the source and destination of the received packet) agrees with the virtual address pair affixed to the packet. Then, the virtual address controller 134 determines whether the condition that the congestion flag is “NO” and at the same time there has been a change in the virtual address pair is fulfilled or not. If the condition is fulfilled, the process proceeds to Step S25; if not, the process proceeds to Step S26.

Step S25: The virtual address controller 134 updates the corresponding path ID in the flow management table 142 by replacing the virtual address pair assigned to the destination and source MAC addresses “c” and “a” until then with the reversal of the virtual destination and source addresses affixed to the received packet. Where no virtual address pair has been assigned yet to the destination and source MAC addresses “c” and “a”, a path ID is newly registered.

Step S26: The VM packet processor 131 outputs the decapsulated packet to the virtual machine VM#1 specified by the destination MAC address “a”, whereupon the process ends.

Step S27: The congestion controller 133 extracts, from the congestion control packet, the pair of MAC addresses (virtual addresses affixed to the tunnel header) of the packet that was discarded because of congestion. Then, the virtual address controller 134 changes the congestion flag associated with the extracted virtual address pair in the virtual address table 141, to “YES”. Also, the virtual address controller 134 searches the flow management table 142 for the MAC address pair associated with the path ID with respect to which the congestion flag has been changed to “YES”, and changes the path ID assigned to the MAC address pair until then to a different path ID.

The following describes examples of how packets output from the virtual machines VM#1 to VM#4 are encapsulated and transmitted after a tunnel is created between the server apparatuses 100 and 100a. It is assumed here that at first the flow management tables 142 and 142a held by the respective server apparatuses 100 and 100a have no entries registered therein.

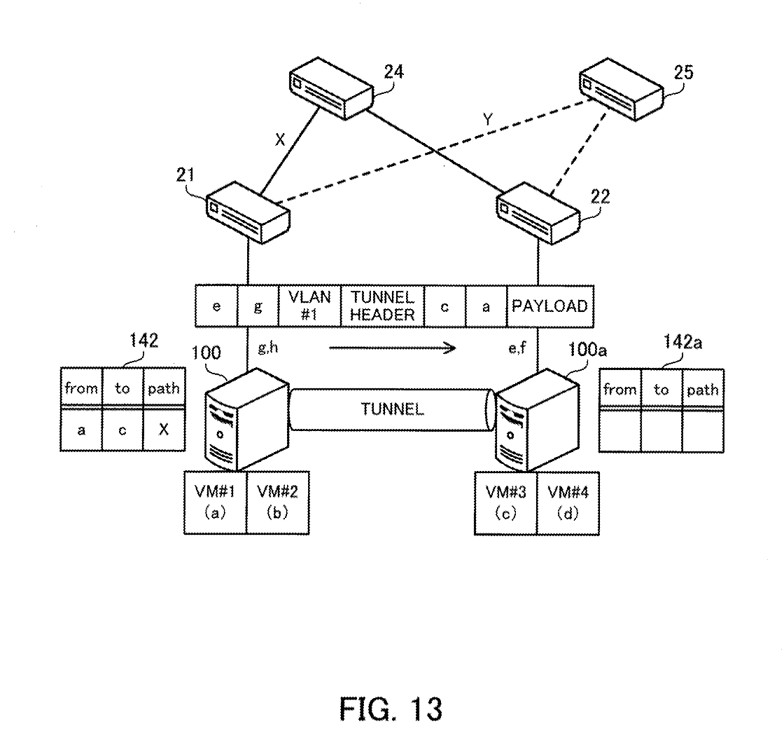

FIG. 13 is a first diagram illustrating an example of packet communication procedure. First, let us suppose that the virtual machine VM#1 transmits a packet to the virtual machine VM#3. The destination and source MAC addresses “c” and “a” are not registered in the flow management table 142. Thus, the server apparatus 100 assigns virtual destination and source addresses “e” and “g” to the MAC address pair and updates the flow management table 142 accordingly. Then, the packet is encapsulated using the assigned virtual address pair and affixed with the VLAN ID “VLAN#1” which is indicative of the path X associated with the virtual address pair. Consequently, the packet output from the server apparatus 100 is forwarded via the switches 21, 24 and 22 (via the path X) and arrives at the server apparatus 100a.

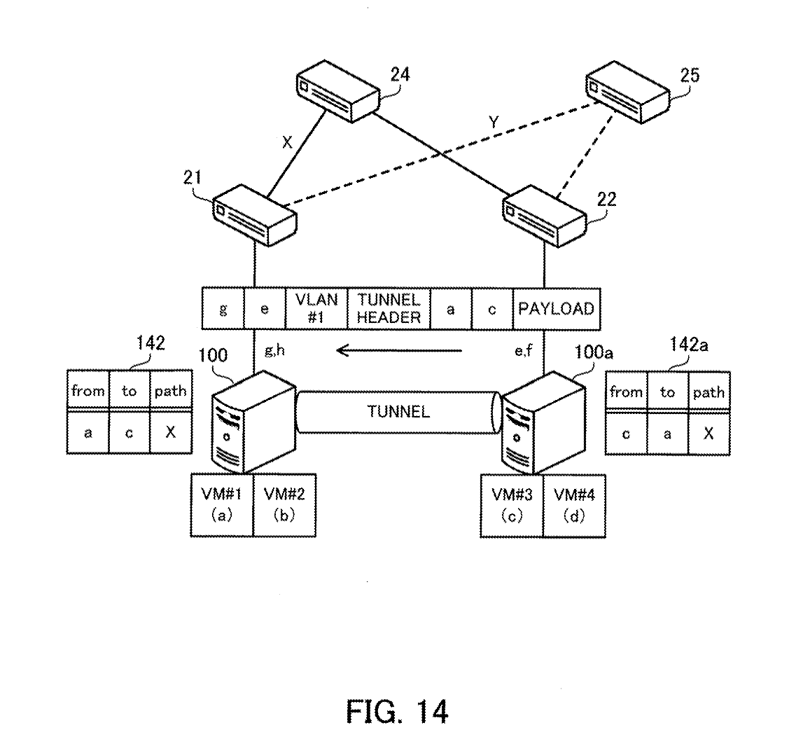

FIG. 14 is a second diagram illustrating an example of packet communication procedure. Let us consider the case where the server apparatus 100a receives the packet explained above with reference to FIG. 13. The destination and source MAC addresses “a” and “c” (reversal of the source and destination of the received packet) are not registered in the flow management table 142a. Thus, the server apparatus 100a assigns the virtual destination and source addresses “g” and “e” (reversal of the source and destination of the received packet) to that MAC address pair and updates the flow management table 142a accordingly.

Let us now consider the case where the virtual machine VM#3 transmits a packet to the virtual machine VM#1. The flow management table 142a has the destination and source MAC addresses “a” and “c” already registered therein. Accordingly, the server apparatus 100a selects the virtual destination and source addresses “g” and “e” assigned to that MAC address pair. The packet is then encapsulated using the selected virtual address pair and affixed with the VLAN ID “VLAN#1” which is indicative of the path X associated with the virtual address pair. Consequently, the packet output from the server apparatus 100a is forwarded via the switches 22, 24 and 21 (via the path X) and arrives at the server apparatus 100.

Let us consider the case where the virtual machine VM#1 receives the above packet from the virtual machine VM#3. The destination and source MAC addresses “c” and “a” (reversal of the source and destination of the received packet) are already registered in the flow management table 142. Also, the virtual address pair assigned to that MAC address pair agrees with the reversal of the source and destination of the received packet. Accordingly, the server apparatus 100 does not update the flow management table 142.

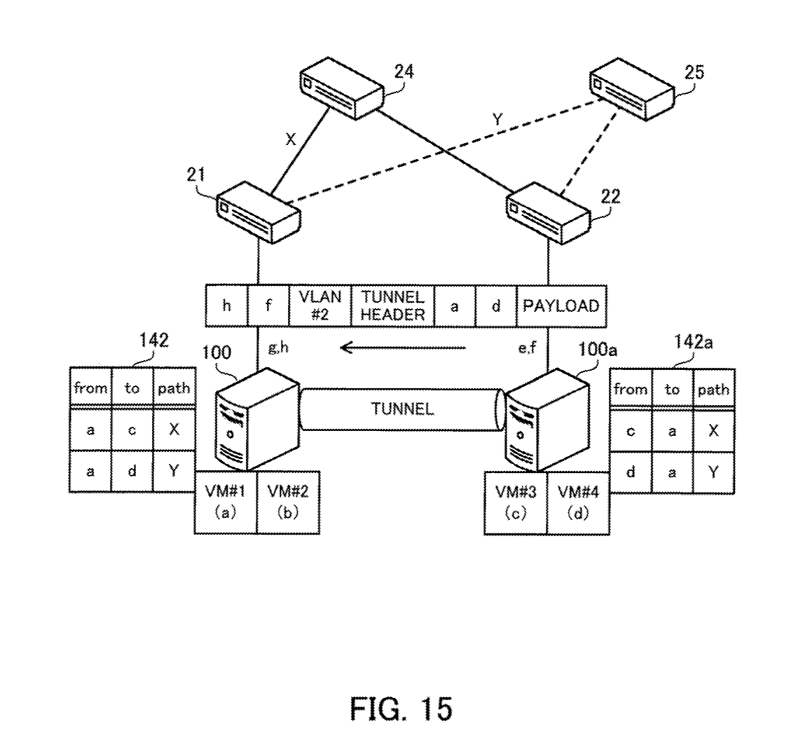

FIG. 15 is a third diagram illustrating an example of packet communication procedure. Let us suppose that the virtual machine VM#4 transmits a packet to the virtual machine VM#1. The destination and source MAC addresses “a” and “d” are not registered in the flow management table 142a. Thus, the server apparatus 100a assigns the virtual destination and source addresses “h” and “f” to that MAC address pair and updates the flow management table 142a accordingly. Then, the server apparatus 100a encapsulates the packet by using the assigned virtual address pair and affixes, to the encapsulated packet, the VLAN ID “VLAN#2” which is indicative of the path Y associated with the virtual address pair. Consequently, the packet output from the server apparatus 100a is forwarded via the switches 22, 25 and 21 (via the path Y) and arrives at the server apparatus 100. Since the path X has been selected in the first entry in the flow management table 142a, the path Y is selected for the second entry by the round-robin method.

Let us now consider the case where the virtual machine VM#1 receives the above packet from the virtual machine VM#4. The destination and source MAC addresses “d” and “a” (reversal of the source and destination of the received packet) are not registered in the flow management table 142. Thus, the server apparatus 100 assigns the virtual destination and source addresses “f” and “h” (reversal of the source and destination of the received packet) to that MAC address pair and updates the flow management table 142 accordingly. In this manner, information is registered symmetrically in the flow management tables 142 and 142a.

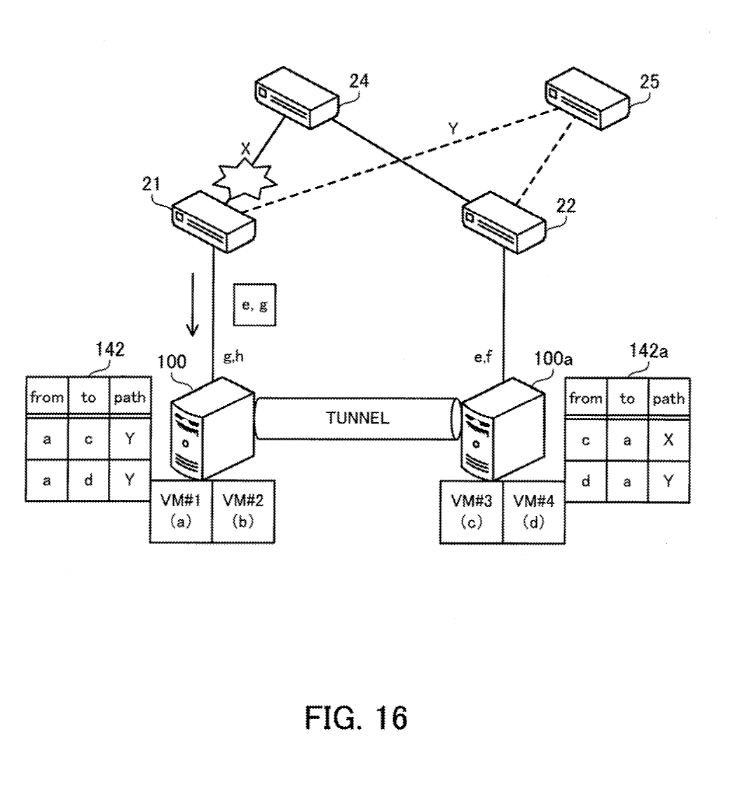

FIG. 16 is a fourth diagram illustrating an example of packet communication procedure. It is assumed here that the link for forwarding packets from the switch 21 to the switch 24 has become congested, with the result that a packet being transmitted from the virtual machine VM#1 to the virtual machine VM#3 is discarded at the switch 21. On detecting congestion, the switch 21 transmits a congestion control packet containing the virtual destination and source addresses “e” and “g” to the server apparatus 100, which is the source of the discarded packet. To detect and notify congestion, the method described in the IEEE (Institute of Electrical and Electronics Engineers) Standard 802.1Qau-2010, 23 Apr. 2010 may be used, for example.

When the congestion control packet is received, the server apparatus 100 sets the congestion flag “YES” with respect to the virtual destination and source address pair “e” and “g” associated with the congested path X, thereby prohibiting the use of the congested path X. Subsequently, the server apparatus 100 changes the corresponding path ID registered in the flow management table 142 so that the path Y may be selected in place of the path X. Consequently, packets transmitted from the virtual machine VM#1 to the virtual machine VM#3 and those transmitted from the virtual machine VM#1 to the virtual machine VM#4 are forwarded via the switches 21, 25 and 22 (via the path Y).

Let us now consider the case where the virtual machine VM#1 receives a packet from the virtual machine VM#3. In the flow management table 142, the destination and source MAC addresses “c” and “a” (reversal of the source and destination of the received packet) have been registered. In this case, the virtual address pair assigned to that MAC address pair disagrees with the reversal of the source and destination of the received packet. However, the congestion flag “YES” has been set with respect to the virtual destination and source address pair “e” and “g” (reversal of the source and destination of the received packet). Accordingly, the server apparatus 100 judges that the disagreement is caused by a change of routing attributable to congestion and does not update the flow management table 142.

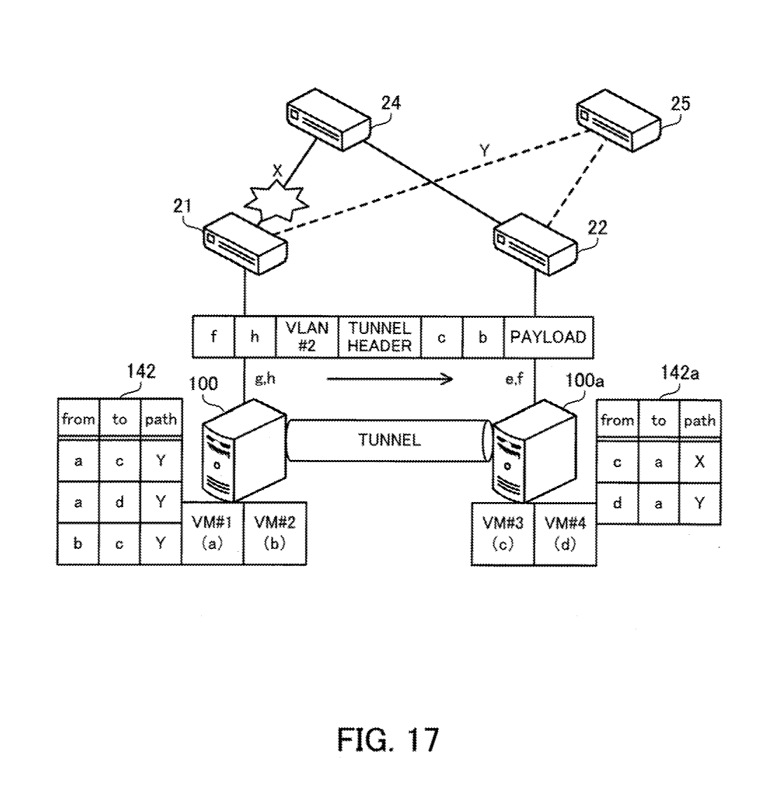

FIG. 17 is a fifth diagram illustrating an example of packet communication procedure. It is assumed here that the virtual machine VM#2 transmits a packet to the virtual machine VM#3. The destination and source MAC addresses “c” and “b” are not registered in the flow management table 142. Thus, the server apparatus 100 assigns the virtual destination and source addresses “f” and “h” to that MAC address pair and updates the flow management table 142 accordingly. Then, the server apparatus 100 encapsulates the packet by using the assigned virtual address pair and affixes, to the encapsulated packet, the VLAN ID “VLAN#2” which is indicative of the path Y associated with the virtual address pair. Consequently, the packet output from the server apparatus 100 is forwarded via the switches 21, 25 and 22 (via the path Y) and arrives at the server apparatus 100a.

In the flow management table 142, the path Y is selected in the second entry, while the selection of the path X is prohibited. Thus, even though the round-robin method is used, the path X is skipped and the path Y is selected also for the third entry, which succeeds the second entry.

In the communication system according to the second embodiment, a plurality of virtual addresses are set for each of the opposite ends of a tunnel, thereby preparing multiple pairs of virtual destination and source addresses that can be used for encapsulation. It is therefore possible to disperse flows among multiple paths set up within the tunneled section in accordance with the virtual destination and source addresses. As a result, encapsulated packets can be efficiently transmitted by making use of the multiple paths. Also, where congestion has occurred on the network 20, paths to be selected can be changed depending on the status of congestion, enabling flexible path selection.

The communication method of the second embodiment can be implemented by causing the server apparatuses 100 and 100a, which function as computers, to execute the communication control program, as stated above. The communication control program may be recorded on computer-readable media (e.g., the recording medium 33). As such recording media, magnetic disk, optical disc, magneto-optical disk, semiconductor memory and the like may be used, for example. The magnetic disk includes HDD and FD, and the optical disc includes CD, CD-R (Recordable), CD-RW (Rewritable), DVD, DVD-R, and DVD-RW.

To put the program in circulation, portable recording media on which the program is recorded are provided, for example. Alternatively, the program may be stored in the storage device of a computer and may be delivered via the network 20. The program recording on a portable recording medium or received from the computer, for example, is stored in the respective storage devices of the server apparatuses 100 and 100a, such as the HDD 103. The server apparatuses load the program from their storage devices and execute the loaded program. Alternatively, the server apparatuses may directly execute the program as the program is read from the portable recording medium or is received from the computer.

With the communication control program, information processing device and packet communication method described above, packets can be transmitted using a plurality of paths.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A non-transitory computer-readable medium storing a communication control program for processing packets that are transmitted through a network in which a tunnel is created and a plurality of paths are set up within a tunneled section of the tunnel, wherein the communication control program causes a computer provided with a storage storing address information which includes a first source address assigned to one endpoint of the tunnel and a first destination address assigned to an opposite endpoint of the tunnel and in which a plurality of entries are set with respect to at least one of the first source and destination addresses, to execute a process comprising:
capturing a first packet including a second source address and a second destination address, and selecting, from the address information, the first source and destination addresses corresponding to the second source and destination addresses; and
affixing the selected first source and destination addresses to a tunnel header of the first packet, to generate an encapsulated second packet.

2. The non-transitory computer-readable medium according to claim 1, wherein:
the storage further stores routing information correlating the first source and destination addresses with identification information for identifying the respective paths within the tunneled section, and
the communication control program causes the computer to further execute a process of: controlling transmission of the second packet in accordance with the routing information so that the second packet may be transmitted via a path associated with the selected first source and destination addresses, among the plurality of paths.

3. The non-transitory computer-readable medium according to claim 1, wherein the communication control program causes the computer to further execute a process of:
acquiring congestion information indicating a path with respect to which congestion has been detected among the plurality of paths; and
imposing restriction on selectable combinations of the first source and destination addresses, among those indicated by the address information, in accordance with the congestion information.

4. An information processing device for processing packets transmitted through a network in which a tunnel is created and a plurality of paths are set up within a tunneled section of the tunnel, the information processing device comprising:
a storage storing address information which includes a first source address assigned to one endpoint of the tunnel and a first destination address assigned to an opposite endpoint of the tunnel and in which a plurality of entries are set with respect to at least one of the first source and destination addresses;
a controller configured to capture a first packet including a second source address and a second destination address, and select, from the address information, the first source and destination addresses corresponding to the second source and destination addresses; and
a transmitter configured to transmit a second packet obtained by encapsulating the first packet and affixing the selected first source and destination addresses to a tunnel header of the first packet.

5. A packet communication method for processing packets transmitted through a network in which a tunnel is created and a plurality of paths are set up within a tunneled section of the tunnel, wherein the packet communication method, implemented by a computer provided with a storage storing address information which includes a first source address assigned to one endpoint of the tunnel and a first destination address assigned to an opposite endpoint of the tunnel and in which a plurality of entries are set with respect to at least one of the first source and destination addresses, the packet communication method comprises:
capturing a first packet including a second source address and a second destination address, and selecting, from the address information, the first source and destination addresses corresponding to the second source and destination addresses; and
transmitting a second packet obtained by encapsulating the first packet and affixing the selected first source and destination addresses to a tunnel header of the first packet.
